(19) United States
(12) Patent Application Publication
(10) Pub. No.: US 2003/0005031 A1
(43) Pub. Date: Jan. 2, 2003

(54) IEEE circuit system

(75) Inventor: Toshimitsu Tsunakawa, Tokyo (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 10/060,189

(22) Filed: Feb. 1, 2002

(30) Foreign Application Priority Data
Jul. 2, 2001 (JP) 2001-030901

(51) Int. Cl. G06F 15/16; G06F 15/177; G06F 9/24; G06F 9/00

(52) U.S. Cl. 709/201; 713/1

(57) ABSTRACT

Terminals A to C constituting a system each include a physical layer 11, a link layer 12, a transaction layer 13 and a register (i.e., configuration ROM) 14 having attribute data 15. By fully or partly writing the attribute data 15 in the register or configuration ROM 14 by a copying operation 16 in the physical layer 11 in advance, any other terminal can quickly make terminal identification without rendering the link layer 12 and the following layers active.

### BACKGROUND OF THE INVENTION

This application claims benefit of Japanese Patent Application No. 2001-030901 filed on Feb. 7, 2001, the contents of which are incorporated by the reference.

The present invention relates to IEEE 1394 circuit systems and, more particularly, to IEEE 1394 circuit systems, which permit rapid and ready communication between terminals capable of communicating with other terminals constituting a system conforming with IEEE 1394 standard.

The IEEE 1394 standard defines an interface bus, which was announced in 1986 by Apple Computer Co., Ltd. in the USA as a serial bus replacing the conventional parallel SCSI (Small Computer System Interface) and standardized in 1995 by IEEE (Institute of Electric Electronic Engineers in the USA) with consideration of connection to PCs (personal computers) and civil electronic apparatuses. The formal name of the standard is “IEEE 1394-1995 Standard for a High Performance Serial Bus”. The IEEE 1394 interface bus is utilized for apparatuses or devices requiring fast data transfer such as HDD (hard disc), and has features that the data transfer rate is high compared to SCSI or the like, that it permits ready connection and that it does not spoil the real time property of data. Prior art concerning such IEEE 1394 interface bus is disclosed in Japanese Patent Laid-Open No. 11-205363 entitled “IEEE 1394 Device Controller” and so forth.

In the IEEE 1394 interface bus, when the protocol stack following (above) a link layer is inactive, attribute data (0 00 04 00h to 0 00 08 00h) of the terminal, which is present in a configuration ROM (read-only memory), could be obtained from any other node after and only after transmitting a link-on packet to all nodes and accessing physical layer, link layer, transaction layer and configuration ROM in the mentioned order until finding of a pertinent node. This state machine has frequent occasions of rendering the link layer and the following layers in unnecessary nodes active, and is therefore impractical.

FIG. 6 is a system schematic for describing the prior art. The system shown in FIG. 6 comprises three terminals A to C. These terminals A to C each includes a physical (PHY) layer 21, a link layer 22, a transaction layer 23 and a configuration ROM 24. The configuration ROM 24 has a register, in which attribute data 25 such as GUID and software version is stored. It is now assumed that the physical layer 21 of the terminal C accesses the physical layers 21 of the terminals A and B in succession. Assuming that the terminal which is desired by the terminal C for communication is the terminal B, the terminal C can determine that the terminal A is other than the one desired for communication with (i.e., terminal B) after and only after checking the physical layer 21, the link layer 22, the transaction layer 23 and the attribute data 25 in the register of the confirmation ROM 24 in the terminal A in the mentioned order. At the time of the checks, the link layer 22 and the following layers should all be rendered active. The terminal C likewise can determine that the terminal B is desired for communication with after and only after checking the physical layer 21, the link layer 22, the transaction layer 23 and the attribute data 25 in the register of the confirmation ROM 24 in the terminal B in the mentioned order. While the FIG. 6 example is a system constituted by the three terminals A to C, like operations apply to systems constituted by four or more terminals.

FIG. 7 is an enlarged view showing one of the above terminals A to C (for instance terminal A) shown in FIG. 6. FIG. 8 is a flow chart for describing the operation of the prior art described above with reference to FIG. 6. When the terminal identification is started (step S51), the request source (for instance terminal C) accesses the physical layer 21 in each terminal (for instance terminal A) (step S52). Then, after the link layer 22 in each terminal is rendered active (step S53), the transaction layer 23 in each terminal is rendered active (step S54). Then, bus-resetting is generated (step S55). Thereafter, the configuration ROM 24 in each terminal is accessed (step S56). After the attribute data 25 written in the configuration ROM 24 is read out (step S57), a check is done as to whether the terminal (for instance terminal A) is the pertinent terminal desired for communication with (step S58). If the terminal is other than the pertinent one (i.e., terminal B) (“No” in step S58), the routine goes back to the step S52), and the steps S52 to S58 are executed with respect to the next terminal (for instance, terminal B). If the terminal is the pertinent one B (“Yes” in step S58), an end is brought to the terminal identification (step S59).

FIG. 9 shows part of the source code in the process of the above prior art at the time of link-on packet generation (in the IEEE 1394-1995 standards). In the first line, the reception of physical (PHY) packet is confirmed. In the second to fifth lines, the received packet is checked. In the sixth and following lines, if the result of the check is right and also if pkt-type (first two bits) is equal to “01” and the third to eighth bits are equal to physical-ID, the generation of the link-on packet is informed.

The prior art described above has some problems. A first problem is that the link layer and the transaction layer which are not needed for communication are subject to being rendered active from a different node, and the layers once rendered active can not be restored to the inactive state from the different node. This is so because the identification of the terminal desired for communication with requires obtaining the attribute data of each terminal by accessing the link layer, the transaction layer and the configuration ROM for each terminal until finding the pertinent terminal.

A second problem resides in increased power consumption. This is so because the link layer and the transaction layer, which follow the physical layer, should also be rendered active.

### SUMMARY OF THE INVENTION

An object of the present invention is to provide an IEEE 1349 circuit system, which permits reading of particular data in the configuration ROM from a different node by utilizing remote-access packet without deviating from the IEEE 1394 standard to be executed without rendering the link layer and the transaction layer active but with the sole physical layer held active.

Another object of the invention is to provide an IEEE 1394 circuit system, which permits suppression of the power consumption in the terminal as much as possible by evading the active-rendering of the layers of the terminal that are unnecessary for communication, i.e., the link layer and the transaction layer.

Other object of the invention is to provide an IEEE 1394 circuit system capable of solving a problem in the prior art IEEE 1394 standard that a complicated procedure is required for obtaining attribute data provided in a configuration POM from any other node in an inactive state of a protocol stack following a link layer.

According to an aspect of the present invention, there is provided an IEEE 1394 circuit system for a terminal comprising a physical layer, a link layer, a transaction layer and a configuration ROM and capable of communicating with any other terminal, wherein the content provided in the configuration ROM is fully or partly copied in the physical layer in advance.

Attribute data of GUID, software version, etc., is copied in the physical layer. The copying of the configuration ROM content in the physical layer is executed at least once until the link layer and the following layers in the terminal are rendered inactive after active-rendering thereof. Only the physical layer in the other terminal is rendered active when the other terminal confirms the opposite side terminal of communication. The physical layer in the terminal has a register, which is necessary and sufficient for copying the attribute data such as GUID, software version, etc. The coping operation is executed in the order of the configuration ROM, the transaction layer, the link layer and the physical layer.

According to another aspect of the present invention, there is provided an IEEE 1394 circuit system for a terminal comprising a physical layer, a link layer, a transaction layer and a configuration ROM and capable of communicating with any other terminal, wherein the content provided in the configuration ROM is fully or partly copied in a register of the physical layer in advance and terminal identification is executed by a first step for accessing the register of the physical layer, a second step for reading out the attribute data having been copied in the register of the physical layer, a third step for checking as to whether this terminal is the pertinent terminal desired for communication with based on the read out attribute data, and a fourth step for executing, if the check proves that the checked terminal is other than the pertinent, the first to third steps until the terminal identification is confirmed.

Other objects and features will be clarified from the following description with reference to attached drawings.

### BRIEF DESCRIPTION OF THE DRAWINGS

FIG. 1 is a system schematic showing outlining a preferred embodiment of the IEEE 1394 circuit system according to the present invention;

FIG. 2 is an enlarged view showing one of the above terminals A to C (for instance terminal A) shown in FIG. 1;

FIG. 3 is a flow chart illustrating the operation in the above IEEE 1394 circuit system shown in FIGS. 1 and 2 according to the present invention;

FIG. 4 is a view for describing the register space configuration constituting the configuration ROM 14;

FIG. 5 is a view for describing the configuration of a link-on packet according to the present invention;

FIG. 6 is a system schematic for describing the prior art;

FIG. 7 is an enlarged view showing one of the above terminals A to C shown in FIG. 6;

FIG. 8 is a flow chart for describing the operation of the prior art described above with reference to FIG. 6; and

FIG. 9 shows part of the source code in the process of the above prior art at the time of link-on packet generation.

### PREFERRED EMBODIMENTS OF THE INVENTION

Preferred embodiments of the present invention will now be described with reference to the drawings.

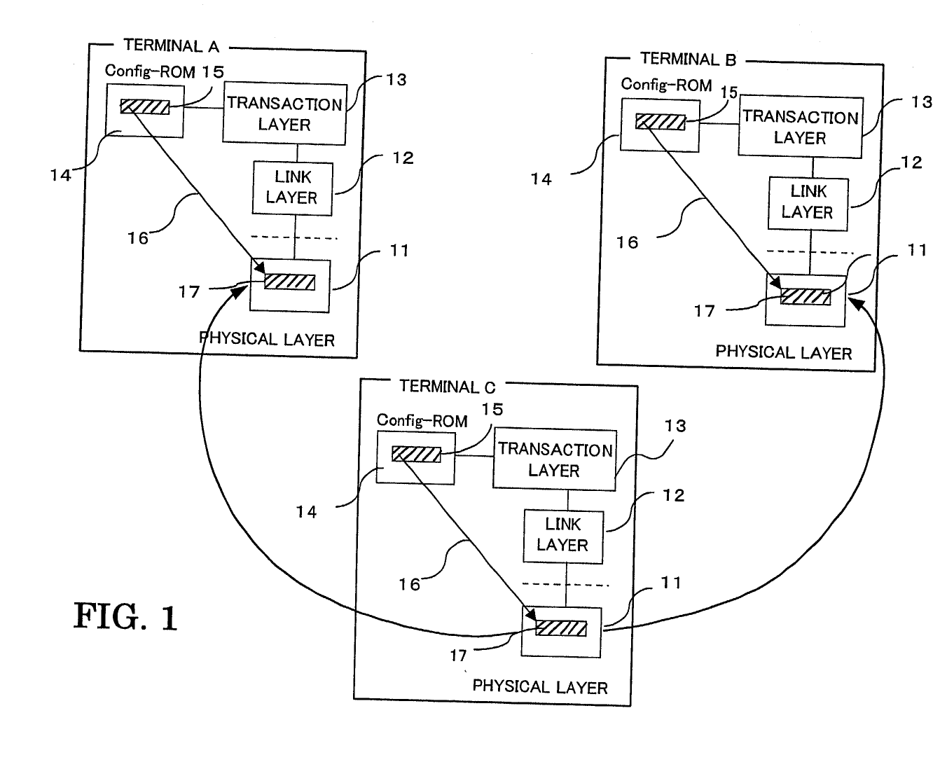

FIG. 1 is a system schematic showing outlining a preferred embodiment of the IEEE 1394 circuit system according to the present invention. The illustrated system comprises terminals A to C. The terminals A to C each include a physical layer 11, a link layer 12, a transaction layer 13 and a confirmation ROM (register) 14. The confirmation ROM 14 has attribute data 15. The terminal attribute data 15 is attribute data of GUID, software version, etc. The attribute data 15 in the confirmation ROM 15 is fully or partly written by copying operation 16 in the physical layer 11.

The physical layer 11 desirably has a register, which is necessary and sufficient for accommodating the attribute data 15. It is assumed that the physical layer 11 is accessed by other terminal. For example, it is assumed that the physical layer 11 in the terminal C accesses the physical layer 11 in the terminals A and C in succession. It is also assumed that the terminal that is desired by the terminal C for communication is the terminal B. The terminal C can immediately determine that the terminal A is other than the one desired for communication with by checking the attribute data 15 copied by copying operation 16 in the register of the physical layer 11 in the terminal A. At this time, the link layer 12 and the following layers are not rendered active. The terminal C likewise immediately determine that the terminal B is the one desired for communication with by checking the attribute data 17 copied in the register of the physical layer 11 in the terminal B. The copying operation 16 is executed at least once until the link layers 12 and the following layers in the terminals A to C are rendered inactive after these layers were rendered active.

While the specific example shown in FIG. 1 is described by the system with three terminals A to C, the same description applies to systems with four or more terminals. In FIG. 1, it is shown that the attribute data 15 in the configuration ROM 14 is just like directly copied by the copying operation 16 in the physical layer 11. Actually, however, the configuration ROM 14, the transaction layer 13, the link layer 12 and the physical layer 11 are accessed in the mentioned order.

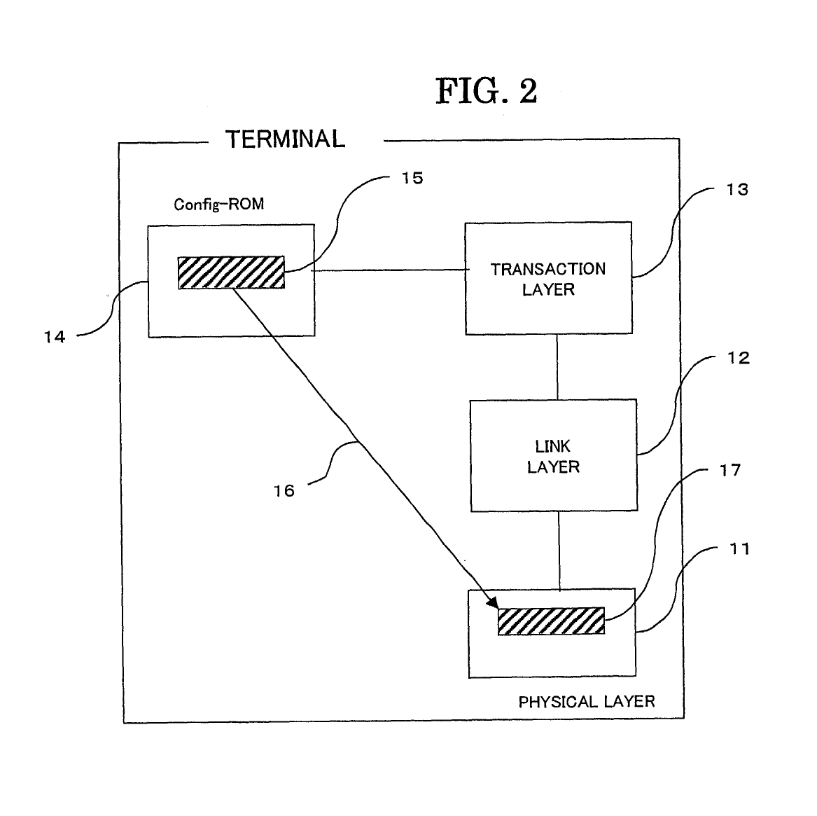

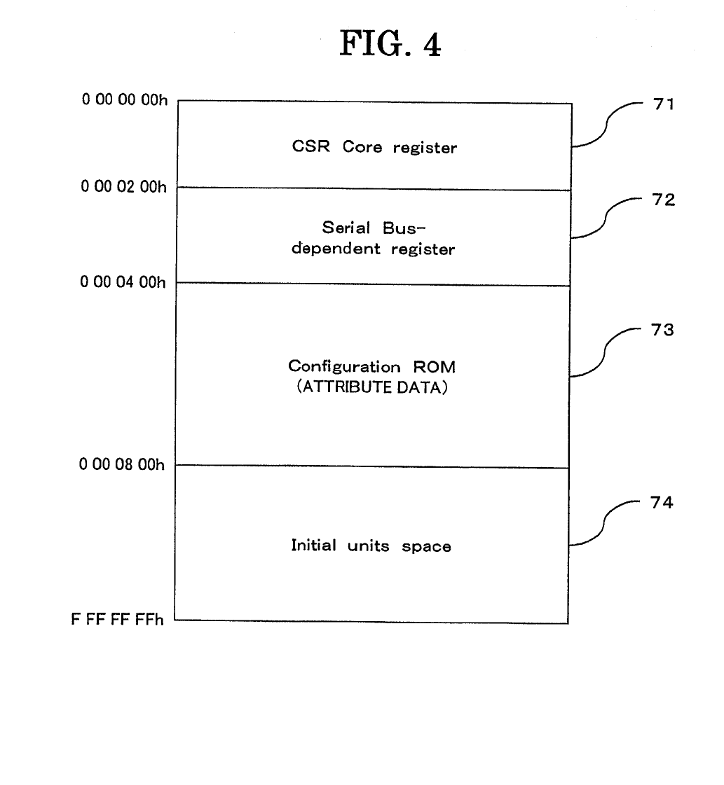

FIG. 2 is an enlarged view showing one of the above terminals A to C (for instance terminal A) shown in FIG. 1. As shown, the FIG. 2 circuit system includes a physical layer 11, a link layer 12, a transaction layer 13 and a configuration ROM 14. In the configuration ROM 14, attribute data 15 of GUID, software version, etc. is stored as will be described later in detail with reference to FIG. 4. The attribute data 17 in the physical layer 11 is obtained by fully or partly writing by the copying operation 16 the attribute data 15 that has been written in the configuration ROM 14. The physical layer 11 desirably has a register, which is necessary and sufficient for accommodating the attribute data 17.

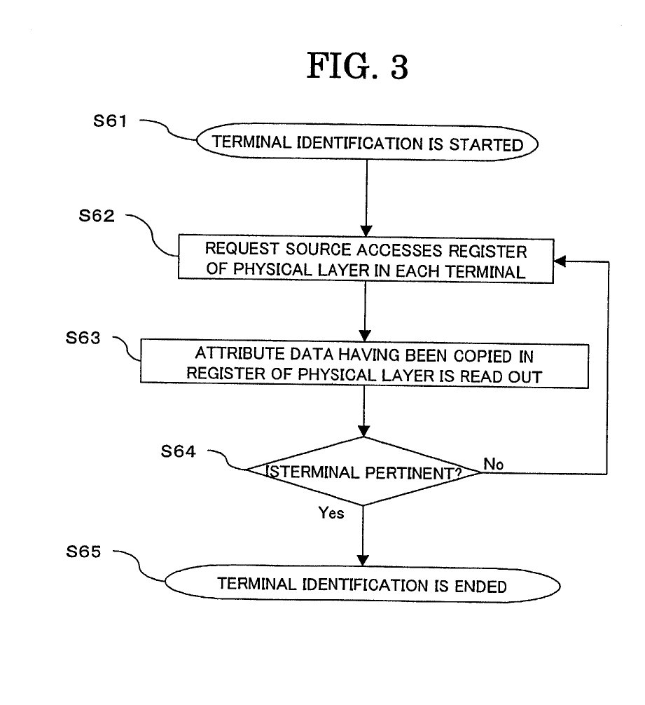

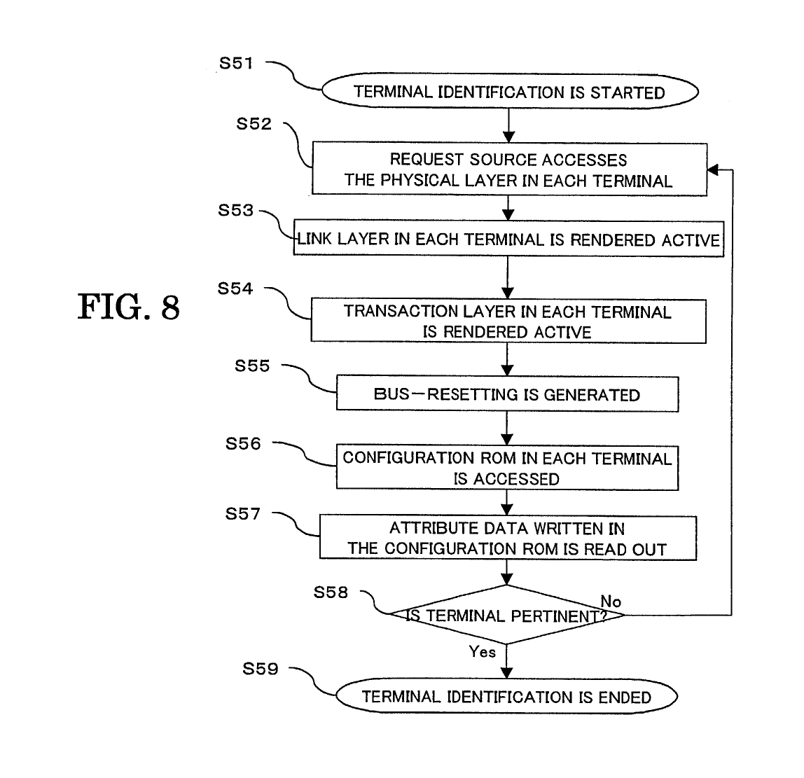

FIG. 3 is a flow chart illustrating the operation in the above IEEE 1394 circuit system shown in FIGS. 1 and 2 according to the present invention. When the terminal identification is started (first step S61), the request source (for instance terminal C) accesses the register of the physical layer 11 in each terminal (for instance terminal A) (step s62). Then, the attribute data 17 having been copied in the register of the physical layer 11 is read out (step S63). Then, a check is executed as to whether this terminal is the pertinent terminal desired for communication with (step S64). If the check proves that the checked terminal is other than the pertinent one (“No” in the step S64), the above steps S62 to S64 are executed repeatedly for the next terminal (for instance terminal B). If the terminal is the pertinent one (“Yes” in step S64), an end is brought to the terminal identification (step S65). Compared to the operation in the prior art as described before with reference to the flow chart of FIG. 8, according to the present invention the terminal identification operation is extremely simplified.

FIG. 4 is a view for describing the register space configuration constituting the configuration ROM 14. As shown, the register is constituted by a CSR core register (0 00 00 00h to 0 00 02 00h) 71, a serial bus-dependent register (0 00 02 00h to 0 00 04 00h) 72, a configuration ROM (0 00 04 00h to 0 00 08 00h) 73 and an initial units space (0 00 08 00h to F FF FFh) 74. Usually, the attribute data 15 is stored in the configuration ROM (0 00 04 00h to 0 00 08 00h) 73 (in conformity to the IEEE 1394-1995 standard). According to the present invention, the written content in the configuration ROM (0 00 04 00h to 0 00 08 00h) 73 is fully or partly written as the attribute data 17 by the copying operation 16 in the physical layer 11.

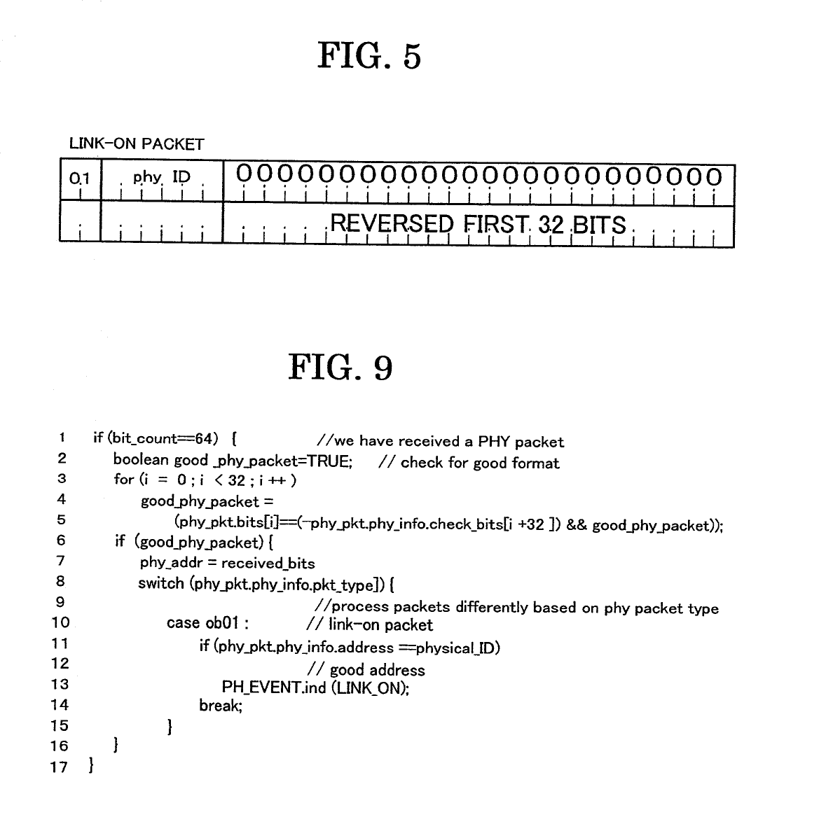

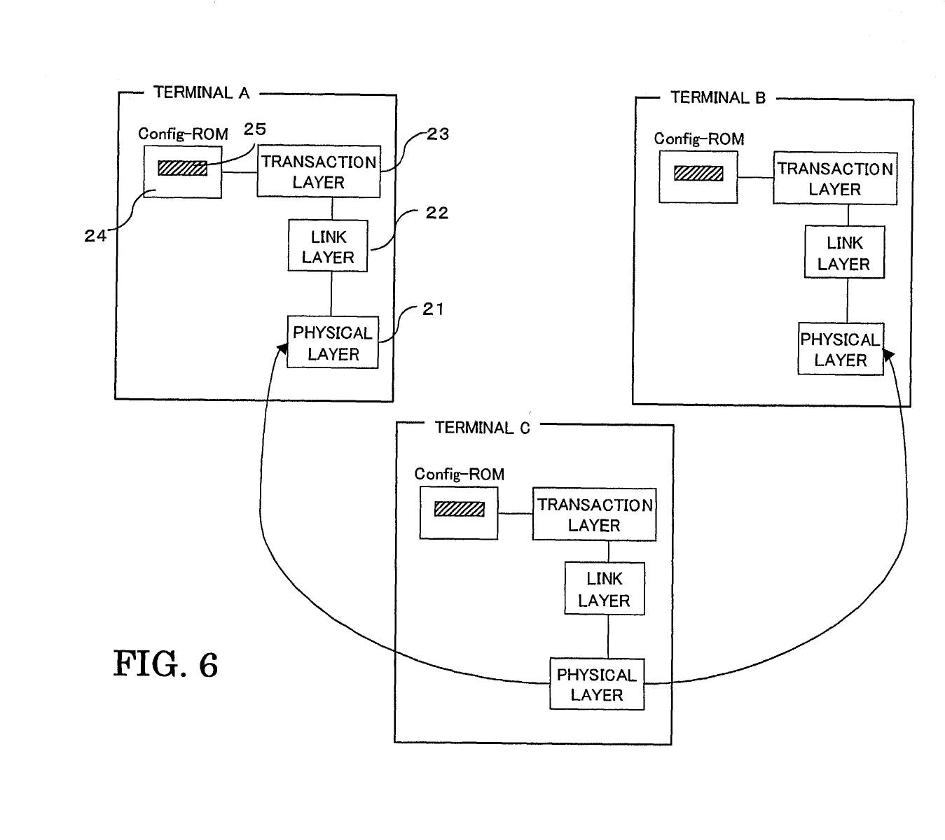

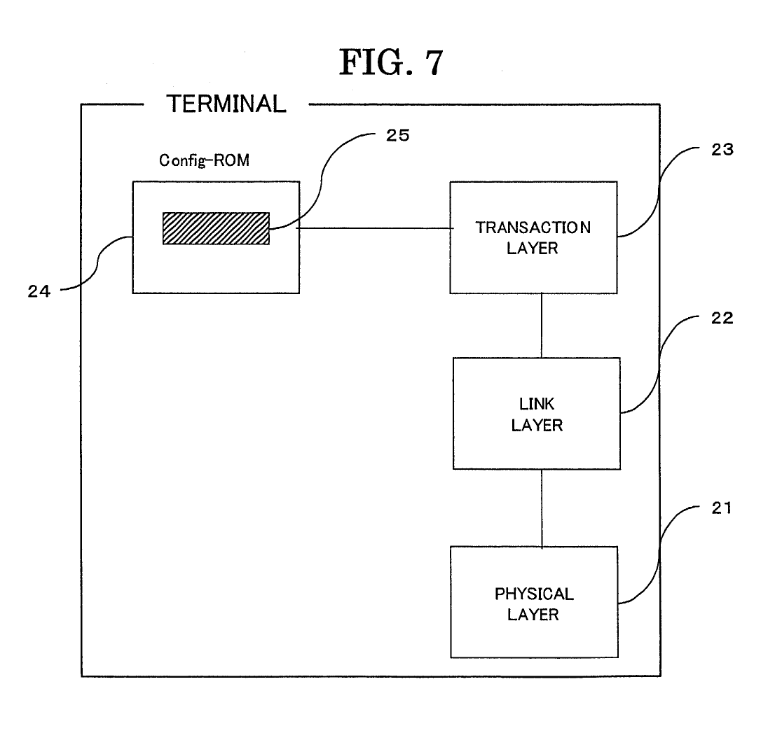

FIG. 5 is a view for describing the configuration of a link-on packet according to the present invention (conforming to the IEEE 1394-1995 standard). By transmitting a link-on packet to a node (or terminal), in which the link layer 12 is not active), this link layer 12 is turned on. In the prior art as described above, for obtaining the attribute data 15 in each of the terminals A to C, it has been necessary to access the configuration ROM 73 shown in FIG. 4. In other words, it has been necessary to transmit the link-on packet such as to render the link layer 12 and the following layers all active. It will be appreciated that, as described before, according to the present invention it is not necessary to generate any wasteful packet (link-on packet).

According to the present invention, the physical layer 11 has a register, which is necessary and sufficient for accommodating the content in the configuration ROM (0 00 04 00h to 0 00 08 00h) shown in FIG. 4. The attribute data in each of the terminals A to C is fully or partly written by the copying operation 16 in a particular register in each of the physical layers 11 at least once until the link layer and the following layers become inactive after the active-rendering thereof. In this case, the procedure of accessing the configuration ROM 14, the transaction layer 13, the link layer 12 and the physical layer 11 in the mentioned order, is completed in advance. (That is, the necessary attribute data 17 is written in the physical layer 11 in advance). As a result, it is no longer necessary to render the layers following the physical layer 11 active by transmitting any link-on packet. For primarily identifying the terminal desired for communication from the other nodes (or terminals), a remote-access packet is used.

A different embodiment of the present invention will now be described. The above embodiment has concerned with communication for terminal identification in the physical layer among the terminals A to C. However, it is also possible to connect monitor or the like having an alarm monitor function to permit the use of the system for such survey as revision confirmation of software installed in the terminals A to C.

As has been described in the foregoing, with the IEEE 1394 circuit system according to the present invention the following practically pronounced effects are obtainable. Firstly, any other node can read out necessary data so long as the physical layer is active. It is thus possible to reduce necessary power consumption. This is so because it is unnecessary to render the layers following the physical layer, i.e., the link layer and the transaction layer, active.

Secondly, since the link layer and the transaction layer need not be rendered active, it is possible to suppress topology complication and reduce the access time. This is so because without rendering the link layer and the transaction layer active the terminal is not connected via any bus, and the topology is formed only between a calling and a called die terminal.

Changes in construction will occur to those skilled in the art and various apparently different modifications and embodiments may be made without departing from the scope of the present invention. The matter set forth in the foregoing description and accompanying drawings is offered by way of illustration only. It is therefore intended that the foregoing description be regarded as illustrative rather than limiting.

What is claimed is:

1. An IEEE 1394 circuit system for a terminal comprising a physical layer, a link layer, a transaction layer and a configuration ROM and capable of communicating with any other terminal, wherein the content provided in the configuration ROM is fully or partly copied in the physical layer in advance.

2. The IEEE 1394 circuit system according to claim 1, wherein attribute data of GUID, software version, etc., is copied in the physical layer.

3. The IEEE 1394 circuit system according to claim 1, wherein the copying of the configuration ROM content in the physical layer is executed at least once until the link layer and the following layers in the terminal are rendered inactive after active-rendering thereof.

4. The IEEE 1394 circuit system according to claim 1, wherein only the physical layer in the other terminal is rendered active when the other terminal confirms the opposite side terminal of communication.

5. The IEEE 1394 circuit system according to claim 1, wherein the physical layer in the terminal has a register, which is necessary and sufficient for copying the attribute data such as GUID, software version, etc.

6. The IEEE 1394 circuit system according to claim 1, wherein the coping operation is executed in the order of the configuration ROM, the transaction layer, the link layer and the physical layer.

7. An IEEE 1394 circuit system for a terminal comprising a physical layer, a link layer, a transaction layer and a configuration ROM and capable of communicating with any other terminal, wherein the content provided in the configuration ROM is fully or partly copied in a register of the physical layer in advance and terminal identification is executed by,
a first step for accessing the register of the physical layer,
a second step for reading out the attribute data having been copied in the register of the physical layer,
a third step for checking as to whether this terminal is the pertinent terminal desired for communication with based on the read out attribute data, and
a fourth step for executing, if the check proves that the checked terminal is other than the pertinent, the first to third steps until the terminal identification is confirmed.
